(19) United States
(12) Patent Application Publication
(10) Pub. No.: US 2025/0277735 A1
(43) Pub. Date: Sep. 4, 2025

(54) SIGNAL DETECTION MECHANISM AND METHOD THEREOF

(71) Applicant: Emerging Viral Diagnostics (HK) Limited, Hong Kong (CN)

(72) Inventors: Lut Hey CHU, Hong Kong (CN); Yuk Lun TSANG, Hong Kong (CN); Johnson Yiu-Nam LAU, Houston, TX (US); Lok Ting LAU, Hong Kong (CN)

(73) Assignee: Emerging Viral Diagnostics (HK) Limited, Hong Kong (CN)

(21) Appl. No.: 18/862,517

(22) PCT Filed: May 3, 2023
(86) PCT No.: PCT/US2023/020785

§ 371 Date: Nov. 1, 2024

Related U.S. Application Data
(60) Provisional application No. 63/338,846, filed on May 5, 2022.

(51) Int. Cl. G01N 21/03; B01L 3/00

(52) U.S. Cl. CPC G01N 21/0303; B01L 3/5085; B01L 2300/0829; B01L 2300/168; G01N 2201/0638

(57) ABSTRACT

A signal detection system comprising a signal amplification module comprising a base, a cover extends away from the base, and a micro-lens structure being formed within a volume created by the base and the cover. A signal amplification module is configured to project a signal from a signal source to a focal plane forming an image of an acquisition or a detection area. An acquisition module is configured to capture the image at the focal plane.

### FIELD OF INVENTION

This invention generally relates to microfluidics technology. More particularly, aspects of the invention relate to a signal detection system for detecting signal from a microfluidic chip or cartridge and a method thereof.

### BACKGROUND

Microfluidic systems are typically used for handling small samples fluid for various purposes, from biochemical analysis to medical diagnostics. The microfluidic systems allow biochemical reactions to be carried out using a small amount of sample and reagent. Microfluidics systems offer a significant cost savings in analysis and diagnostics of samples.

Microfluidic systems integrate assay operation on a single microfluidic chip or cartridge. The assay operation usually involves moving the liquid through microfluidic channels to different sectors inside a chip for sample pre-treatment, sample preparation and detection.

Generally, optical detection method is used because they are robust, sensitive, non-destructive and broadband. Among optical detection methods, fluorescence sensing is most popular. Signal-to-noise ratio (SNR) is used to determine the performance of an optical detector and high SNR is desirable as it general improves the sensitivity of an optical detection system.

Typical optical signal detection system for microfluidic systems detects signal from a single fluidic or reaction chamber. In order to detect signals from multiple fluidic chambers, multiple detectors would be needed. Further, if only one detector is used, it would need to take reading for each fluidic chamber. It significantly increases the cost and the time required to detect signals from multiple fluid chambers.

### SUMMARY

In view of the foregoing background, aspects of the invention provide an improved signal detection system for a microfluidic system and method where the cost, size, reliability and high SNR become the critical factors of such improvements.

To alleviate the issues, aspects of the invention provide a signal amplification module which concentrates, collimates and maximizes the signal intensity from a signal source in a fluidic chamber.

According to another aspect, embodiments of the invention provide another advantage over existing system where the displacement between the signal and the acquisition unit, (e.g., “H” in FIG. 1). According to some aspects, the microlens embodiments may control the H such that the overall system size or configuration may be adjusted or even minimized to a size that can accomplish many applications, such as portability, overall space or height required, etc.

In yet another aspects of the present invention, the signal amplification module further projects the signal on a focal plane forming an image of a detection area with a signal spot. On the microfluidic chip or cartridge, the signal source generates an original signal footprint. The size of the signal spot is much smaller than the original signal footprint, however, the signal to non-signal area ratio on the image is increased compared to the signal to non-signal area ratio on the original footprint. The increased signal to non-signal area ratio on the image may increase the number of pixels of an optical detector (for example, Charge-coupled device (CCD)) that could receive signal from the signal spot.

In yet another aspects of the present invention, the signal amplification module may projects a plurality of signals from a plurality of signal sources and forming an image of the detection area with plurality of signal spots, wherein each signal spot corresponds to respective signal source and does not overlap.

In yet another aspects of the present invention, multiple images with signal spots may be projected, re-allocated or re-arranged in different spatial area at the same or different focal plane. Signal spots at different regions on the detected area may be grouped into different images. Each of the image may be on the same of different focal plane as other image. The variety of the configuration depends on the application and/or the system design with the detector's arrangement.

In yet another aspects of the present invention, multiple signal spots may be detected by an optical detector at once.

Accordingly, embodiments of the present invention, in one aspect, a signal amplification module comprising a base and a cover connecting with the base to create a volume therebetween. In one embodiment, the volume may create a micro-lens structure.

In yet another aspect, a signal detection system comprising a base and a cover connecting with the base to create a volume therebetween. In one embodiment, the volume may create a micro-lens structure. Further, in yet another embodiment, a fluidic chamber may be disposed within the micro-lens structure, and the fluidic chamber may include a film disposed on the base.

In yet another aspect, a signal detection system comprising a signal source and a signal amplification module. In one embodiment, the signal amplification module comprises a base, and a cover connecting with the base to create a volume therebetween. In one embodiment, the volume creates a micro-lens structure, and the signal amplification module may be configured to project a signal from the signal source to a focal plane forming an image.

In yet another aspect, a signal detection system comprises a signal source and a signal amplification module. In one aspect, the signal amplification module includes a base and a cover connecting with the base to create a volume therebetween. The volume may create a micro-lens structure, and a fluidic chamber disposed within the micro-lens structure. The fluidic chamber may include a film disposed on the base, and the signal amplification module may be configured to project a signal from the signal source to a focal plane forming an image.

In a further embodiment, a signal detection system may include a first layer and the first layer may include a signal amplification module. In one embodiment, the signal amplification module may include a base and a cover connecting with the base to create a volume. In one aspect, the volume may create a micro-lens structure. In another aspect, the signal amplification module may include a second layer, and the second layer may include a microfluidic chamber. In one embodiment, the second layer may be disposed below the first layer.

### BRIEF DESCRIPTION OF FIGURES

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a schematic view of a signal detection mechanism for a microfluidic system according to one embodiment of the invention.

FIG. 2 is a schematic view of another signal detection mechanism for a microfluidic system according to another embodiment of the invention.

FIG. 3 is a cross-sectional view of a signal amplification module for a microfluidic chip or cartridge according to one embodiment of the present invention.

FIG. 4 is a cross-sectional view of another signal amplification module for a microfluidic chip or cartridge according to another embodiment of the present invention.

FIGS. 5-8 illustrate optical arrangements of the microfluidic system according to one embodiment.

FIG. 9 illustrates examples of image formation on a focal plane according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

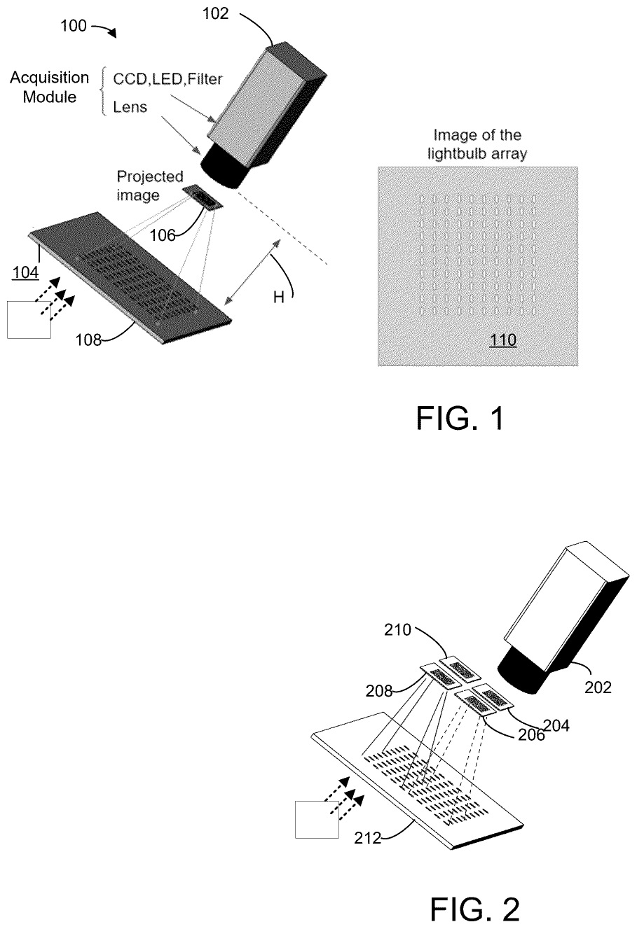

Referring to FIG. 1, a signal detection mechanism 100 for a microfluidic system. The mechanism 100 may include a signal amplification module 104 and a signal acquisition module 102. The signal amplification module 104 may be configured to receive light signal from a light source. In one embodiment, the light source may include one or more light bulbs or light emitting objects that emit light toward the module 104. In one embodiment, the light source may be arranged as shown in 110 as an array of lightbulbs. The module 104 may, through the designs as described in subsequent figures, project a signal on the module 104 with a support 108. In one embodiment, the module 104 may include a number of microfluidic chip or cartridge, and the number of microfluidic chip or cartridge may redirect or rearrange the light signal to a focal plane for acquisition or detection by the signal acquisition module 102. In one embodiment, the signal acquisition module 102 may acquire, detect or process a projected image 106. In one embodiment, the signal acquisition module 102 may be a camera or a photodiode configured to receive the signal. In one embodiment, the signal acquisition module 102 may be a device capable of capturing or acquiring the image.

The signal may be generated from the signal source in a fluidic chamber having an original signal footprint on the microfluidic chip or cartridge. For example, the chip or cartridge 10 may be in a configuration or arrangement as shown in FIG. 1 to receive the light source. In one embodiment, the projected image may be on the focal plane 106, and the plane 106 may be disposed away from a surface of the signal amplification module 104 at a predetermined distance. Unlike prior approaches where a single lens (e.g., one lens) is used without using the microlens of embodiments of the invention, the image plane may get smaller, but the signal to non-signal area ratio would be maintained at the same level. On the other hand, according to aspects of the invention, the size of the signal spot may be smaller than the original signal footprint, however, the signal to non-signal area ratio on the image may be increased compared to the signal to non-signal area ratio on the detection area. This features enable the mechanism 100 to control the displacement between the signal and the acquisition unit (“H”) in FIG. 1. As such, the overall size of the mechanism 100 may be controlled or adjust for a number of applications. For example, the mechanism 100 may be adjusted to fit to the limit space or height constraints of the use. It is to be understood that the control of H may provide other benefits without departing from the scope and spirit of the invention.

In one example, the acquisition module 102 may include an optical detector, such as a Charge-coupled device (CCD) or a Complementary metal oxide semiconductor (CMOS) sensor. In one example, an increased signal to non-signal area ratio on the image may increase the number of pixels of, the CCD or CMOS of the acquisition module 102 that could receive signal from the signal spot.

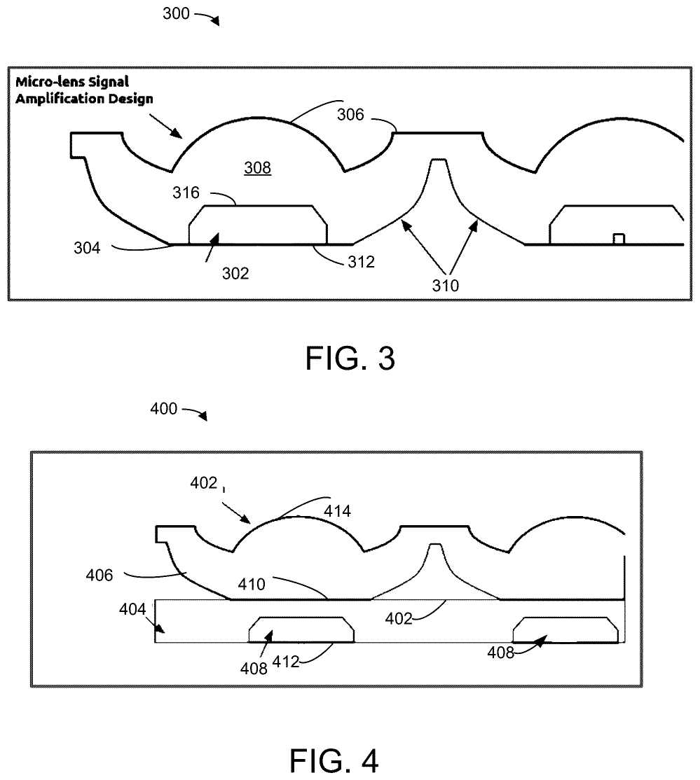

Referring now to FIG. 3, a signal amplification module 300 may be further configured to concentrate, collimate and maximize the signal intensity from the signal source in a fluidic chamber. As such, the intensity of the signal spot could be heightened.

In some embodiments, the signal amplification module 300 may project a plurality of signals from a plurality of signal sources and form an image of the detection area with plurality of signal spots, wherein each signal spot corresponds to respective signal source and does not overlap.

The acquisition module 102 may be configured to capture the projected image and detect the signal from the signal spot on the projected image. The acquisition module is further configured to detect signals from multiple signal spots simultaneously. The acquisition module 102 may include photodiode configured to receive the signal from the signal spot, lens and filter configured to enhance the signal detection by the photodiode, and optional light source, which may be used to excite the signal source in the fluidic chamber (if signal source requires additional excitation to generate signal). In some embodiments, the photodiode may be CCD or CMOS. In some embodiments, the light source may include LED. It is to be understood that other means to increase the sensitivity of the signal for the acquisition module 102 may be used without departing from the scope or spirit of the invention.

In some embodiments, the signal detection mechanism 100 may be used to detect the signal from a set of microfluidic channels.

In another embodiment, the image of the lightbulb array 108 may be seen as in 110.

In another embodiment, FIG. 2 is a diagram illustrating another embodiment of the signal detection mechanism 100. In this embodiment, an acquisition module 202 may be able to detect one or more projected images 204 through 210 in FIG. 2 based on the innovative design of the amplification module 300.

Referring to FIG. 3, a cross-sectional view of a signal amplification module 300 according to one embodiment. In one embodiment, the module 300 may include a base 304 and a cover 306, wherein the cover 306 may be connected with the base 304 to create a volume 308. In one embodiment, the volume 308 may create a micro-lens structure between the base 304 and the cover 306. In one embodiment, the cover 306 may include an area or a portion of surfaces that face the acquisition module. In another embodiment, the base 304 may include an area or a portion of surfaces that are underneath or below the cover 306.

In another embodiment, the module 300 may include a fluidic chamber 302 disposed within the volume 308. In one example, the fluidic chamber 302 may include a separate cover 316. The separate cover 316 of the fluidic chamber 302 may form a volume where a film 312 closes the opening of the cover 316. In other words, the film 312 may connect with the base 304. As such, in one embodiment, in the event the film 312 is not disposed or positioned for the fluidic chamber 302, the base 304, the separate cover 316 and the cover 306 may be connected to form the volume 308.

In some embodiments, the cover 306 may be concave, convex, or other parabolic shape in a transparent material to enable light to leave the volume 308. In yet another embodiment, the cover 306 may have other shapes that having desirable refractive properties that may be suitable for providing projected images to be acquired or captured by the acquisition module 102 or 202.

In one embodiment, the base 304 may include one or more sidewalls 310. For example, the sidewalls 310 may be coated with a reflective material. In one embodiment, the reflective material may be coated on a surface facing the cover 306 or the acquisition module 102 or 202. In another embodiment, the reflective material may be coated on a surface facing the light source. In one embodiment, the entire surface of the base 304 may be coated with the reflective material. In one embodiment, the fluidic chamber 302 may become a reaction chamber as being a closed or sealed space where the film 312 is used. In another embodiment, the reflective coating layer may be configured to reflect the signal from the fluidic chamber 302 to concentrate, collimate and maximize the signal intensity. In some embodiments, the reflective coating may be aluminum, silver, gold or other metallic coating. Those skilled in the art will appreciate that the choice of coating material, the thickness and the roughness of the reflective coating shall depend on the intended application of the microfluidic system, as well as cost, and other practical factors.

In one embodiment, the module 300 may be injection molded and a plurality of modules 300 may be placed on a plate or sheet to fit for any use. In one embodiment, the sheet of the modules 300 may be positioned substantially horizontally to receive light from a light source, as shown in FIG. 1.

In one aspect, the micro-lens 308 may project the signal the light source and through the cover 306 so that redirected signal may be collected by the acquisition module. In one embodiment, a valve (not shown) containing a material (e.g., substance to be tested) such that the material is exposed to the light signal and be subjected to imaging. In one embodiment, the signal passing through the module 300 may be projected to a predetermined area on the projected image, such as one of them in FIG. 2 or 106 in FIG. 1. In one embodiment, the predetermined area on the projected image may correspond to a plane of the fluidic chamber 302 on a monitored area on the microfluidic chip or cartridge. In some embodiments, the micro-lens 308 may be made of plastics including but not limited to polystyrene (PS), polycarbonate (PC), cyclic olefin copolymer (COC), cyclic olefin polymer (COP), polymethyl methacrylate (PMMA), polyethylene terephthalate (PET), polyether ether ketone (PEEK) and silicones. It is to be understood that other materials may be used without departing from the scope or spirit of the invention.

According to another aspect, FIG. 4 illustrates another signal amplification configuration according to some embodiments. In one example, according to FIG. 4, the signal amplification configuration 400 may include a first layer 402 and a second layer 404. The first layer 402 may include a signal amplification module 406 that is similar to that in FIG. 3 and therefore some of the descriptions may not be repeated below. In the configuration 400, however, instead of the chamber 302 being disposed within the volume 308 (e.g., within the base 304 and the cover 306), a chamber 408 may be disposed in the second layer 404. In such arrangement, the module 406 may not be in a fluid communication with the chamber 408. In such an arrangement, the module 406 may be provided as an add-on to an existing chamber 408 as a separate unit.

In one embodiment, the module 406 may include a base 410 that may not need to include a reflective material or possess reflective features.

In some embodiments, as shown in FIGS. 3 and 4, multiple chambers may be disposed on a chip or cartridge, as depicted in FIG. 1. While FIGS. 3 and 4 only show two of these amplification modules, it is to be understood that additional rows and columns of amplification modules may be disposed on a surface of the plate. The micro-lenses may project a plurality of signals from a plurality of signal sources and forming an image of the detection area with plurality of signal spots, wherein each signal spot corresponds to respective signal source and does not overlap, such as the one shown in 110. In some embodiments, multiple images at different or same focal plane may be formed. In yet some embodiments, the signal spots on each of the multiple images may be from different fluidic chambers. In yet some embodiment, each multiple image represents signals from fluidic chambers from particular section of the microfluidic chip or cartridge.

In some embodiments, the reflective coating as discussed in at least FIG. 3 may be aluminum, silver, gold or other metallic coating. Those skilled in the art will appreciate that the choice of coating material, the thickness and the roughness of the reflective coating shall depend on the intended application of the microfluidic system.

In some embodiments, the fluidic chamber may be suitable for holding the material as part of preforming polymerase chain reaction (PCR), quantitative polymerase chain reaction (qPCR) and the signal may be fluorescence, color dye, colorimetric indicators, quantum dots or illuminating substances, etc.

In some embodiments, the amplification module as shown FIGS. 3 and 4 may project a plurality of images based on the location of the signal generated on the microfluidic chip or cartridge. The projected images may be on the same or different focal plane, which is away from the surface of the microfluidic chip or cartridge at a predetermined distance. The acquisition module may move to a position corresponding to each projected image to capture thereof at the corresponding focal plane to detect the signals. In some other embodiments, the acquisition module may capture all the projected image at once and detect the signals.

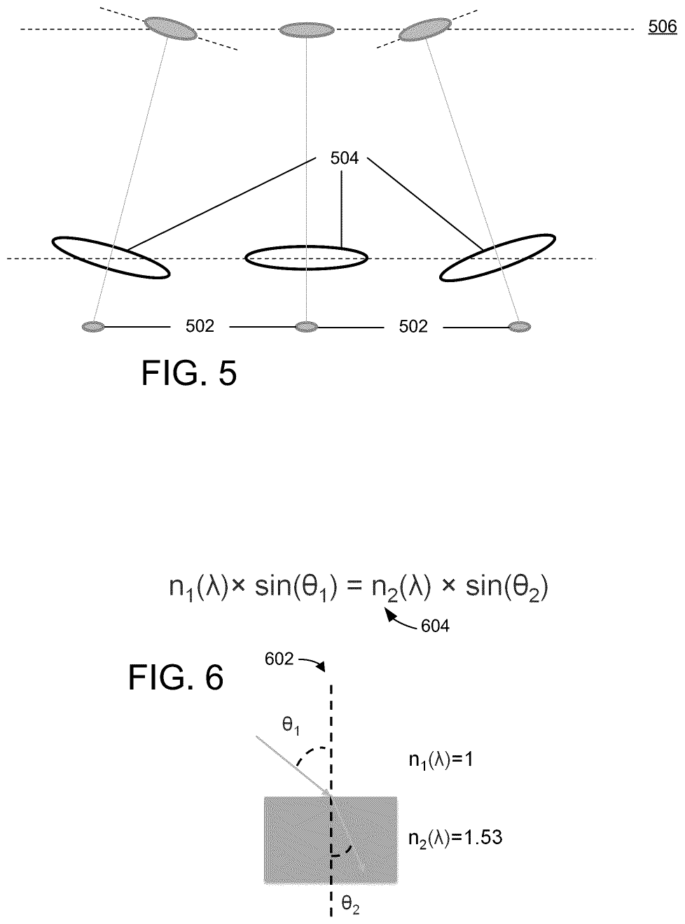

For example, FIG. 5 illustrates a diagram illustrating three fluidic chambers according to one embodiment. For example, three different chambers 502 are subjected to the signal and through the micro-lens and the cover 306, projected images may be formed on a defined focal plane at 506. In this example, based on the focal length and the angle of signal (e.g., light beams) of the micro-lens on each reaction chamber or fluidic chamber, the signal may be steered, refracted, or redirected so that a location and magnitude of the image on the focal plane can be configured or defined at the focal plane 506.

In general, light refraction may follow the general concept as illustrated by the graph 602 and the formula 604 in FIG. 6. In one example, the refraction angle of a light ray passing through from one medium to another one is governed by the refraction equation by knowing the refractive indexes of the two adjacent media. With knowing the refractive index of the liquid medium (the signal source), the material of the cartridge (chamber) and the air, the lens system may be simulated and designed in a precise or configured manner. In one example, the refractive index depends on the wavelength. Therefore, the working wavelength is one of the considerations in the micro-lens design.

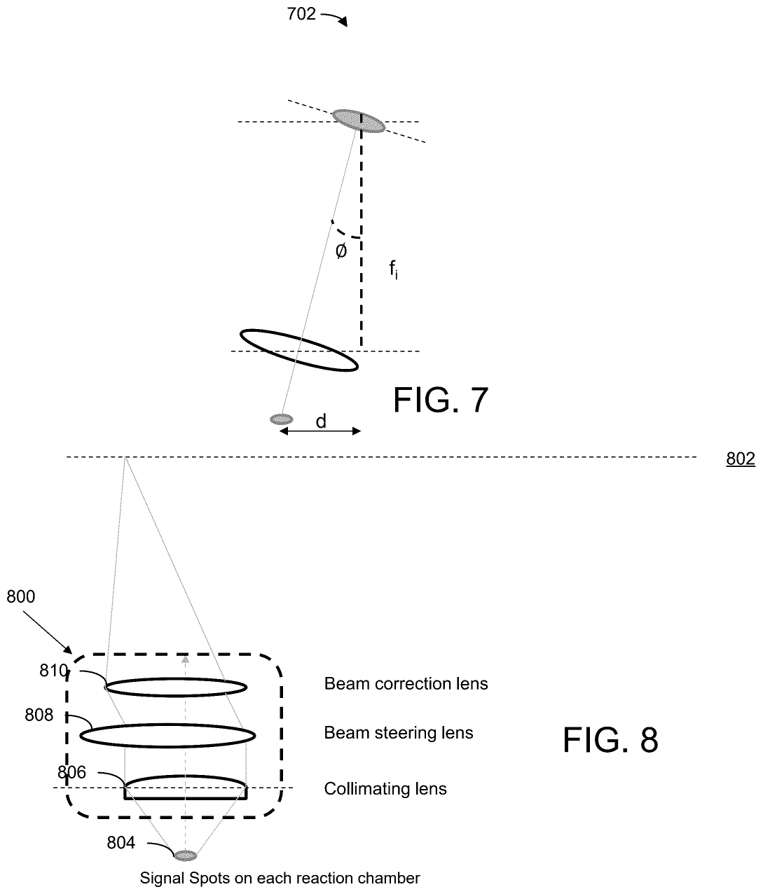

In one embodiment, according to FIG. 7, a lens formula (1) may be used:

$$\frac{1}{f} = \frac{1}{{f}_{i}} + \frac{1}{{f}_{o}} \qquad ( 1 )$$

where,
f=focal length of the lens,
fᵢ=distance of the image from the lens,
fₒ=distance of the object from the lens.

In addition, a tile angle of the beam may be represented by the following formula (2) and illustrated by the illustration 702 in FIG. 7.

Ø=tan⁻¹(d/fᵢ) 2
where,
Ø=tile angle of the beam,
fᵢ=distance of the image from the lens,
d=distance of the image shifted.

In one example, (1) with defined distance between the single lens and the focal plane, the focal length of the single lens may be defined. (2) With defined location of the image to be formed on the focal plane, the tilt angle of the image may be defined. In one aspect, compound lens may be designed which is more complex than simple lens, however, the compound lens may allow single thin lens formula with combined effect. In one example, the micro-lens may be designed with the aid of the computer program. As such, the signal source and the expected image formation on the focal plane may be configured or defined that is tailored to the application of the overall system.

In another aspect, according to FIG. 8, aspects of the invention provide a micro-lens design 800 that may combine a collimating lens 806, a beam steering lens 808 and a beam correction lens 810 to redirect a signal spot 804 to a focal plane 802. It is understood that other lens combination may be used without departing from the scope or spirit of the invention. In addition, the arrangements of the collimating lens 806, the beam steering lens 808 and the beam correction lens 810 may be re-configured without departing from the scope or spirit of the invention.

For example, the beam correction lens 810 may determine the image size formation at the focal plane. In another example, the beam steering lens 808 may fulfil any beam steering angle for lens tilting, lens shift, etc.

For example, the collimating lens 806 may be designed to collimate the signal spot from the defined chambers to form a light beam. One of the purposes is to maximize the signal collection. Achromatic lens design rule may be incorporated if large wavelength difference of more than one signal light source in one reaction chamber.

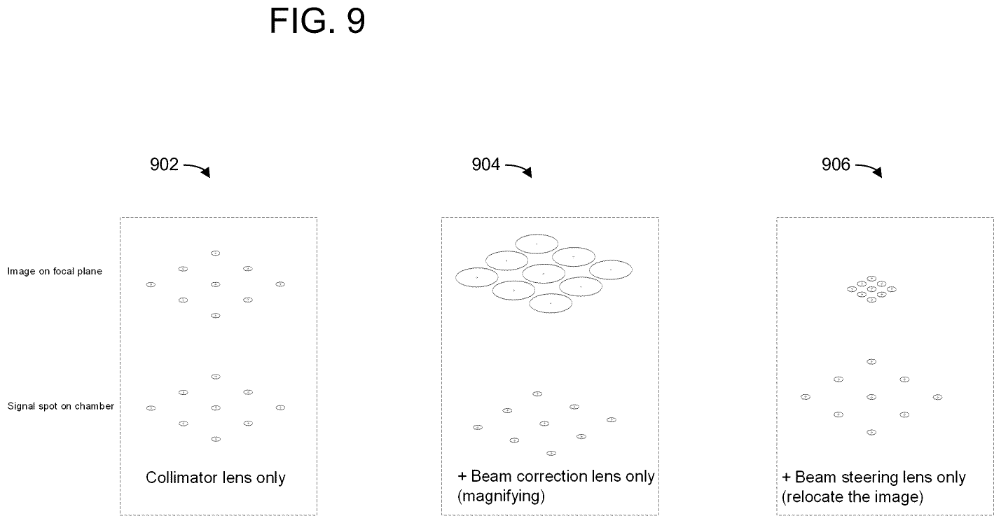

Furthermore, FIG. 9 illustrates diagrams 902, 904 and 906 where results of the collimating lens 806, the beam steering lens 808 and the beam correction lens 810 are used. In some embodiments, the fluidic chamber may be suitable for preforming polymerase chain reaction (PCR), quantitative polymerase chain reaction (qPCR) and the signal may be fluorescence, color dye, colorimetric indicators, quantum dots or illuminating substances, etc.

Now refer to the operation of the signal detection mechanism. In some embodiments, signal may be generated in the fluidic chamber due to the presence of an analyte. In one embodiment, as the analyte enters the fluidic chamber, qPCR is performed with primers coupled to fluorochromes and the analyte. Signal may be generated due to the presence of the analyte. The signal, in this embodiment, fluorescent light is emitted from the fluidic chamber to the amplification module. A portion of the emitted fluorescent light transmits directly to the micro-lens and a portion of the fluorescent light transmits to the cover surface and may be reflected to the micro-lens. The micro-lens projects the fluorescent light to a focal plane which is away from the surface of the microfluidic chip or cartridge at a predetermined distance. The acquisition module then captures the projected image and detects the signal in the image.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

The microfluidic system may be used in various applications, including but not limited to, biological, chemical, or diagnostic assays and method thereof.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

While the present disclosure may be embodied in many different forms, the drawings and discussion are presented with the understanding that the present disclosure is an exemplification of the principles of one or more inventions and is not intended to limit anyone embodiment to the embodiments illustrated.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

1. A signal amplification module comprising:
a base; and
a cover connecting with the base to create a volume therebetween;
wherein the volume creates a micro-lens structure.

2. The signal amplification module of claim 1, wherein the cover comprises a curved transparent material.

3. The signal amplification module of claim 1, further comprising a fluidic chamber disposed on the base.

4. The signal amplification module of claim 1, wherein the base includes one or more sidewalls.

5. The signal amplification module of claim 4, wherein the one or more sidewalls comprise a reflective coating thereon.

6-8. (canceled)

9. A signal detection system comprising:
a signal source;
a signal amplification module comprising,
a base;
a cover connecting with the base to create a volume therebetween;
wherein the volume creates a micro-lens structure, and
a fluidic chamber disposed within the micro-lens structure, wherein the fluidic chamber comprises a film disposed on the base; and
wherein the signal amplification module is configured to project a signal from the signal source to a focal plane forming an image.

10. The signal detection system of claim 9, further comprising an acquisition module configured to capture the image at the focal plane.

11. A signal amplification configuration comprising:
a first layer, wherein the first layer comprises a signal amplification module, wherein the signal amplification module comprises:
a base;
a cover connecting with the base to create a volume therebetween;
wherein the volume creates a micro-lens structure;
a second layer, wherein the second layer comprises a microfluidic chamber; and
wherein the second layer is disposed below the first layer.

12. The signal amplification configuration of claim 11, the cover comprises a curved transparent material.

13. The signal amplification configuration of claim 11, wherein the second layer comprises a base.
